(19) United States
(12) Patent Application Publication
(10) Pub. No.: US 2020/0015083 A1
(43) Pub. Date: Jan. 9, 2020

(54) Robust Physical Layer Slope Authentication Method in Wireless Communications and Apparatus

(71) Applicant: Shenzhen University, Shenzhen (CN)

(72) Inventors: Ning XIE, Shenzhen (CN); Li ZHANG, Shenzhen (CN); Hui WANG, Shenzhen (CN)

(73) Assignee: Shenzhen University, Shenzhen (CN)

(21) Appl. No.: 16/574,152

(22) Filed: Sep. 18, 2019

Related U.S. Application Data
(63) Continuation of application No. PCT/CN2017/105069, filed on Sep. 30, 2017.

(51) Int. Cl. H04W 12/06; H04W 52/36; H04L 1/00; H04W 52/24

(52) U.S. Cl. CPC H04W 12/06; H04W 52/241; H04L 1/0026; H04W 52/36

(57) ABSTRACT

In a wireless communication system, a transmitter sends a signal in the form of a number of channel blocks, onto some of which is superimposed an authentication signal. A receiver then uses probabilistic methods that take channel fading into account to determine how many blocks include the authorization signal, and then compares this number with a threshold value. This information may then be used by the transmitter to adjust transmission power.

### CROSS-REFERENCE TO RELATED APPLICATIONS

This application is a “bypass” continuation under 35 U.S.C. § 111(a) of international application (filed under the Patent Cooperation Treaty—PCT) No. PCT/CN2017/105069, filed Sep. 30, 2017, for “Robust Physical Layer Slope Authentication Method in Wireless Communications and Apparatus”, which is incorporated herein by reference.

### TECHNICAL FIELD

The present disclosure relates to communication devices, and in particular to a wireless communication method and apparatus.

### BACKGROUND ART

There are three main physical layer authentication technologies. The first authentication technology is the Spread Spectrum Authentication method (Auth-SS). The basic idea is to use traditional direct-sequence spread spectrum or frequency-hopping technology. The second one is based on the Auth-TDM (Authentication with Time Division Multiplexed Tag). The basic idea is that the transmitting device periodically sends information signals and tag information alternately. After receiving the signal, the receiving device directly extracts the desired tag information to implement authentication of the signal. The third authentication technology is the Authentication with Superimposed Tag (Auth-SUP). The basic idea is to use a key to superimpose the tag information on the information signal, and then the transmitting device simultaneously transmits the signal, and after the receiving device receives the signal, the tag information in the superimposed signal is extracted by using the key to achieve the purpose of signal authentication.

However, the above three physical layer authentication technologies (Auth-TDM, Auth-SS, and Auth-SUP) may not effectively combat the noise impact of the channel fading and the receiving device, and sacrifice performance when the training sequence is long. That is, the robustness is poor.

### BRIEF DESCRIPTION OF THE DRAWINGS

FIG. 1 is a schematic structural diagram of a communication system according to some embodiments;

FIG. 2 is a schematic flowchart of a wireless communication method according to some embodiments;

FIG. 3 is a schematic flowchart of another wireless communication method according to some embodiments;

FIG. 4 is a schematic diagram of a power allocation mechanism according to some embodiment of the present invention;

FIG. 5 is a schematic flowchart of another wireless communication method according to some embodiments;

FIG. 6 is a schematic diagram of an equivocation change curve regarding a authentication property of different quantity of channel blocks to SNR according to some embodiments;

FIG. 7 is a schematic diagram of an equivocation change curve of a authentication property to a power parameter adjustment factor according to some embodiments;

FIG. 8 is a schematic structural diagram of a wireless communication apparatus according to some embodiments; and

FIG. 9 is a schematic structural diagram of a wireless communication apparatus according to some embodiments.

### DETAILED DESCRIPTION

The technical solutions in the embodiments of the present invention will be clearly and completely described in the following with reference to the accompanying drawings. It is apparent that the described embodiments are only some of the embodiments of the invention, and not all possible embodiments. All other embodiments obtained by those skilled in the art based on the embodiments of the present invention without creative efforts are within the scope of the present invention.

It should be noted that the terms “first” and “second” and the like in the specification and claims of the present invention and the above drawings are used to distinguish different objects, and are not intended to describe a specific order. Furthermore, the terms “comprises” and “comprising” are intended to cover a non-exclusive inclusion. For example, a process, method, system, product, or device that comprises a series of steps or units is not limited to the listed steps or units, but optionally also includes steps or units not listed, or, other steps or units optionally inherent to these processes, methods, products or equipment.

The disclosure discloses a wireless communication method and device, which may improve the robust of information transmission. The details are described below.

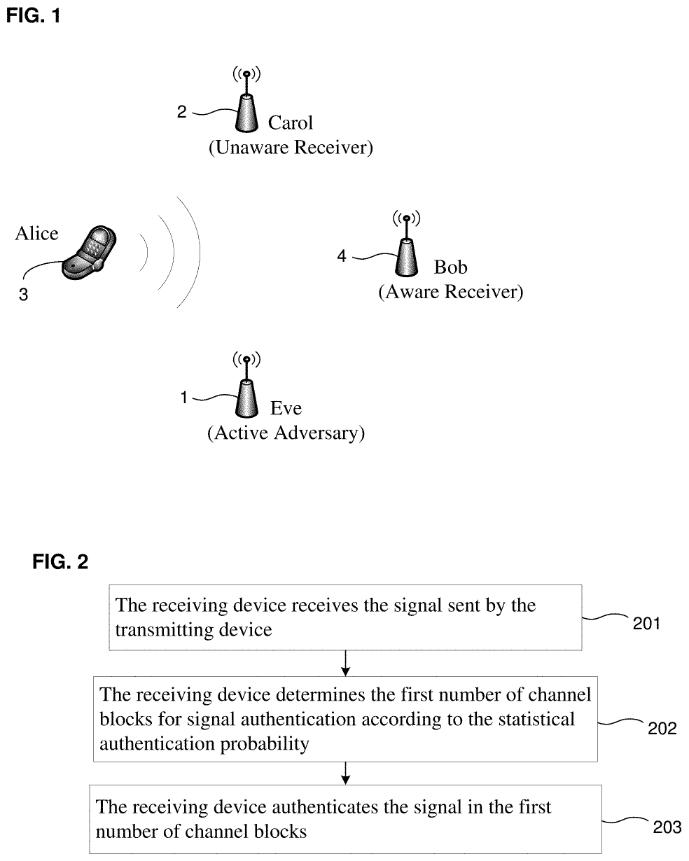

Please refer to FIG. 1. FIG. 1 is a schematic structural diagram of a communication system according to an embodiment. As shown in FIG. 1, the communication system may include a transmitting device 3 (shown as Alice), an aware receiver 4 (shown as Bob), an actively adversarial audio monitor device 1 (shown as Eve) and an unaware audio monitor device 2 (Carol).

The transmitting device 3 (Alice) is authorized and is mainly used for transmitting a label signal that needs to be authenticated. A signal with a label added is called a label signal, and a signal without the label is called a regular signal. The transmitting device may include, but is not limited to, a base station and user equipment. A base station (e.g., an access point) may refer to a device in an access network that communicates with a wireless terminal by one or more sectors over an air interface. The base station, as a router between the wireless terminal and the rest of the access network, may convert received air frames to the IP group. The remainder of the access network may include an Internet Protocol (IP) network. The base station may also coordinate attribute management of the air interface. For example, the base station may be a GSM or CDMA base station (BTS, Base Transceiver Station), or a WCDMA base station (NodeB), or a LTE-evolved base station (NodeB or eNB or e-NodeB, evolutional Node B). The user equipment may be various types of electronic devices. For example, the user equipment may be a smart phone, a notebook computer, a personal computer (PC), a personal digital assistant (PDA), a mobile internet device (MID), a wearable device (such as a smart watch, a smart bracelet, smart glasses), etc. An operating system of the user device may include, but is not limited to, an Android operating system, an IOS operating system, a Symbian operating system, a BlackBerry operating system and Windows Phone 8 operating system, and so on, which are not limited in the embodiment of the present disclosure.

The aware receiver 4 (Bob) is an authorized device. The aware receiver 4 receives signals and determines whether the signal is a regular signal or a tag signal. The aware receiver 4 may include, but is not limited to, a base station and user equipment. A base station (e.g., an access point) may refer to a device in an access network that communicates with a wireless terminal over one or more sectors by an air interface. The base station may be used to convert the received air frames to IP packets as a router between the wireless terminal and the rest of the access network, wherein the remainder of the access network may include an Internet Protocol (IP) network. The base station may also coordinate attribute management of the air interface. For example, the base station may be a GSM or CDMA base station (BTS, Base Transceiver Station), or may be a WCDMA base station (NodeB), or may be an evolved LTE base station (NodeB or eNB or e-NodeB, evolutional Node B), the embodiment of the present disclosure is not limited. The user equipment may include, but is not limited to, a smart phone, a notebook computer, a personal computer (PC), a personal digital assistant (PDA), a mobile internet device (MID), a wearable device (such as a smart watch). Various types of electronic devices, such as smart bracelets and smart glasses, wherein the operating system of the user device may include, but is not limited to an Android operating system, an IOS operating system, a Symbian operating system, and a BlackBerry operating system, the Windows Phone 8 operating system and so on are not limited in the embodiment of the present disclosure.

The active adversary 1 (Eve) is an unauthorized receiving party (i.e., a hostile user), and mainly monitors signals sent by the transmitting device. Once the signal sent by the transmitting device is found to contain authentication information (i.e., a tag signal), the signal will be analyzed, and the hostile user will try to extract, destroy, and even tamper with the authentication information.

The unaware receiver 2 (Carol) is a relatively neutral receiver, and may receive the signal transmitted by the transmitting device 3 but has no idea of the authentication method, and does not attempt to analyze whether the received signal contains the authentication information. It does not interfere with the signal.

It should be noted that the transmitting device 3, the aware receiver 4, the active adversary 1 and the unaware receiver 2 in the communication system described in FIG. 1 may be different kinds of devices. That is, the number of the transmitting devices 3 in the communication system is not limited to one, and the number of the aware receivers 4 in the communication system described in FIG. 1 is not limited to one. Similarly, the number of active adversaries 1 in the communication system described in FIG. 1 is not limited to only one, and the number of the unaware receivers 2 in the communication system described in FIG. 1 is not limited to one.

In the communication system described in FIG. 1, it is assumed that the signal transmitted by the transmitting device is transmitted in blocks, expressed as b={b₁, K, b_{L}}, where the length of each block is L, and different signal blocks are independent and identically distributed random variables. Furthermore, the channels between different devices are modeled as fast-fading channels, which means that the channel fading corresponding to different signal blocks is also independent. Based on the above assumptions, the signal received by the receiving device may be expressed as follows:

yᵢ=hᵢxᵢ+nᵢ

where the original transmission signal code sequence b={b₁, K, b_{L}} undergoes code modulation, pulse shaping, and so on, to get sᵢ, and then the label signal is added to sᵢ, to get xᵢ. That is, xᵢ may contain the label signal and the information signal hᵢ=lᵢηᵢ is the channel response. In the present disclosure, the Nakagami channel ηᵢ represents a random variable with short-term fading, lᵢ=λ/4πd is the path loss, λ=c/f_{c} is the signal wavelength, c=3×10⁸ m/s, f_{c} is the carrier frequency of the signal, d is the distance between the transmitting device 3 and the aware receiver 4, and nᵢ=nᵢ₁, nᵢ₂, . . . , n_{iL}, Nᵢₖ˜ [symbol] (0, σ²ₙ) is Gaussian white noise.

As a summary of one feature of some embodiments, there is a “training stage” between the legitimate transmitter and receiver. In this training stage, the legitimate receiver feed backs channel state information (CSI) to the transmitter, and based on these CSIs, the transmitter estimates the authentication performance. In the communication stage, if the performance in the training stage does not satisfy a robustness requirement, the transmitter adjusts power parameter adjustment factors. This is described in grater detail below.

Specifically, the transmitting device 3 may divide the signal to be sent into multiple packets by using a pre-agreed key, and obtain a preset authentication probability. Next, the transmitting device 3 may determine a first power parameter adjustment factor corresponding to the preset authentication probability according to a correspondence between the authentication probability and the power parameter adjustment factor. Then, according to the energy-limited condition of the to-be-transmitted signal power and the first power parameter adjustment factor, the transmitting device 3 may determine a power parameter adjustment factor from the power parameter adjustment factors of the plurality of packets other than the first power parameter adjustment factor. For each of the packets, the power adjustment parameter of the group may be used to perform power adjustment on the signal of the group. Afterwards, the transmitting device 3 transmits the signal to be transmitted after the power adjustment. After receiving the signal, the aware receiver 4 may determine a first number of channel blocks for performing signal authentication according to the statistical authentication probability; and perform authentication on the signal in the first number of channel blocks. The aware receiver 4 knows the label signal and the encryption mode added by the transmitting device, and agrees with the transmitting device in advance as to which key to use. The above-summarized physical layer authentication arrangement may be referred to as “slope authentication technology” (Auth-SLO).

It may be seen that before transmitting the to-be-sent signal, the transmitting device 3 may use the key agreed upon by the two parties to group the transmitted signals, determine a power parameter adjustment factor for each packet according to the authentication probability and the energy limited condition, and adjust the power of each packet of signals by using the determined power parameter adjustment factor. At the same time, the aware receiver 4 may also determine the first number of channel blocks performed by signal authentication according to the authentication probability, and then perform authentication of the signals in the first number of channel blocks. That is, the signals in the multiple channel blocks are authenticated. Authentication of the signals in the multiple channel blocks may be more robust than authentication of signals in a single channel block, whereby the robustness of information authentication may be ensured.

The wireless communication method may be applicable to the aware receiver 4. As shown in FIG. 2, the wireless communication method may include the following steps:

In step 201, the aware receiver 4 receives the signal sent by the transmitting device 3.

In one embodiment, the signal sent by the aware receiver 4 to the transmitting device 3 may be expressed as:

y_{i,1}=hᵢx_{i,1}+n_{i,1}

y_{i,2}=hᵢx_{i,2}+n_{i,2} (1.1)

where the signal-to-interference-plus-noise ratio (SINR) of the aware receiver 4 is,

$${SINR}_{Auth \text{-} SLO} = \frac{{‖ {h}_{i} ‖}^{2} ( {α}^{2} + {β}^{2} )}{2 {σ}_{n}^{2}} = {γ}_{i} \qquad ( 1.2 )$$

As may be seen from the above formula, the superimposed tag signal does not sacrifice the SINR of the aware receiver 4. At this time, for the aware receiver 4, it is not necessary to estimate the channel parameter (channel fading), there is no need to compensate the channel, and there is not even a need to demodulate and decode the signal. By judging whether the received signal conforms to the power distribution characteristics of the transmitting device 3, the received signal may be authenticated.

In step 202, the aware receiver 4 determines the first number of channel blocks for signal authentication according to a statistical authentication probability.

In one embodiment, suppose f_{Y}(y) is the probability density function of Y and F_{Y}(y) is the cumulative distribution function of Y, where Y=∥X₁∥²−∥X₂∥², X₁˜CN(0, σ₂²), and X₂˜CN(0, σₙ²), then there is the following expression:

$$\begin{matrix}{f}_{Y} ( y ) = \{ \begin{matrix}\frac{1}{2 {σ}_{n}^{2}} exp ( \frac{y}{{σ}_{n}^{2}} ) , & y < 0 \\ \frac{1}{2 {σ}_{n}^{2}} exp ( - \frac{y}{{σ}_{n}^{2}} ) , & y \geq 0\end{matrix} & ( 1.3 ) \\ {F}_{Y} ( y ) = \{ \begin{matrix}\frac{1}{2} exp ( \frac{y}{{σ}_{n}^{2}} ) , & y < 0 \\ 1 - \frac{1}{2} exp ( - \frac{y}{{σ}_{n}^{2}} ) , & y \geq 0\end{matrix} & ( 1.4 )\end{matrix}$$

For a block fading channel, because the fading coefficients hᵢ are constant during one block and the receiver noise is an i.i.d. RV, the test statistic of each symbol makes the same contribution to the decision rule. This independent property over each symbol makes the Auth-SLO method robust on the block length. Thus, to simplify the decision rule, the PFA of the Auth-SLO method for the ith block, based on the derived distribution in (1.3) and (1.4), can be denoted as,

$${P}_{i , PFA} = P r \{ {τ}_{i} {\sum }_{k = 1}^{L / 2} {τ}_{i , k} > {θ}_{i} \vert {H}_{0} \} = P r \{ {τ}_{i} \frac{L}{2} {τ}_{i , k} > {θ}_{i} \vert {H}_{0} \} = P r \{ {τ}_{i , k} > \frac{2 {θ}_{i}}{L} \vert {H}_{0} \} = 1 - {F}_{Y} ( \frac{2 {θ}_{i}}{L} ) = \frac{1}{2} exp ( - \frac{2 {θ}_{i}}{L {σ}_{n}^{2}} ) \qquad ( 1.5 )$$

Then, from (1.5), the optimal threshold θᵢ⁰ of this test for the ith block may be determined for a false alarm probability ε_{FA}, which can be calculated as

$${θ}_{i}^{0} = \frac{L {σ}_{n}^{2}}{2} l g \frac{1}{2 {ɛ}_{FA}} \qquad ( 1.6 )$$

Now, one may derive the PD of the Auth-SLO method. Since τᵢ|H₁ can be regarded as the sum of the RV Z=|X₁²|−|X₂²|, where X₁˜CN(Ti, σₙ²), Tᵢ=|hᵢ|² (α²−β²) and X₂˜CN(0, σₙ²), because

$${τ}_{i} \vert {H}_{1} = {\sum }_{k = 1}^{L / 2} {τ}_{i , k} \vert {H}_{1} ,$$

where τ_{i,k}|H₁=(|hᵢ|²(α²−β²)+|n_{i,1}(l_{1,k})|²)−|n_{i,2}(l_{2,k})|². The PDF and CDF of Z are denoted as f_{Z}(z) and F_{Z}(z), respectively, and expressed as,

$$\begin{matrix}{f}_{z} ( z ) = \frac{1}{2 {σ}_{n}^{2}} exp ( \frac{2 z - {T}_{i}^{2}}{2 {σ}_{n}^{2}} ) {Q}_{1} ( \sqrt{\frac{{T}_{i}^{2}}{{σ}_{n}^{2}}} , \sqrt{\frac{4 z}{{σ}_{n}^{2}}} ) , z \geq 0 \\ and & ( 1.7 ) \\ {F}_{z} ( z ) = 1 - {Q}_{1} ( \sqrt{\frac{2 {T}_{i}^{2}}{{σ}_{n}^{2}}} , \sqrt{\frac{2 z}{{σ}_{n}^{2}}} ) + \frac{1}{2} exp ( \frac{2 z - {T}_{i}^{2}}{2 {σ}_{n}^{2}} ) {Q}_{1} ( \sqrt{\frac{{T}_{i}^{2}}{{σ}_{n}^{2}}} , \sqrt{\frac{4 z}{{σ}_{n}^{2}}} ) , z \geq 0 & ( 1.8 )\end{matrix}$$

where Q₁ (α,β) is the first-order Marcum Q-function.

Then, for the optimal threshold θᵢ⁰ defined in (1.6), the PD of the Auth-SLO method for the ith block, based on the distribution derived in (1.7) and (1.8), can be denoted as,

$${P}_{i , PD} = P r \{ {τ}_{i} {\sum }_{k = 1}^{L / 2} {τ}_{i , k} > {θ}_{i}^{0} \vert {H}_{0} \} = P r \{ {τ}_{i , k} > \frac{2 {θ}_{i}^{0}}{L} \vert {H}_{1} \} = 1 - {F}_{z} ( \frac{2 {θ}_{i}^{0}}{L} ) {Q}_{1} ( \sqrt{\frac{2 {T}_{i}^{2}}{{σ}_{n}^{2}}} , \sqrt{\frac{4 {θ}_{i}^{0}}{L {σ}_{n}^{2}}} ) - \frac{1}{2} exp ( \frac{4 {θ}_{i}^{0} \text{/} L - {T}_{i}^{2}}{2 {σ}_{n}^{2}} ) {Q}_{1} ( \sqrt{\frac{{T}_{i}^{2}}{{σ}_{n}^{2}}} , \sqrt{\frac{8 {θ}_{i}^{0}}{L {σ}_{n}^{2}}} ) \qquad ( 1.9 )$$

By substituting (1.6) into (1.9), one obtains:

$${P}_{i , PD} = {Q}_{1} ( \sqrt{\frac{2 {T}_{i}^{2}}{{σ}_{n}^{2}}} , \sqrt{2 lg \frac{1}{2 {ɛ}_{FA}}} ) - \frac{1}{2} exp ( lg \frac{1}{2 {ɛ}_{FA}} - \frac{{T}_{i}^{2}}{2 {σ}_{n}^{2}} ) {Q}_{1} ( \sqrt{\frac{{T}_{i}^{2}}{{σ}_{n}^{2}}} , \sqrt{4 lg \frac{1}{2 {ɛ}_{FA}}} ) \qquad ( 1.10 )$$

From (1.10), one can see that the PD of the Auth-SLO method is independent of L.
The PD of a randomly chosen block with a random channel realization is

P_{D}=∫P_{i,PD}f_{γ}(γ)dγ (1.11)

where f_{g} (g) is the PDF of the SNR.
The aware receiver 4 may calculate the authentication probability according to the above formula.

Specifically, the aware receiver 4 determines, according to the statistical authentication probability, the first number of channel blocks for performing signal authentication by using a routine that includes:
computing the authentication probability according to the received signal;
determining whether the authentication probability is greater than an authentication probability threshold; and
if yes, the value corresponding to the authentication probability threshold is determined, and the number corresponding to the authentication probability threshold is determined as the first number of channel blocks for signal authentication.

In this embodiment, an authentication probability threshold may be preset, wherein the authentication probability threshold may be determined in advance by multiple implementations, and the authentication probability threshold corresponds to the number of channel blocks.

After the aware receiver 4 gets the authentication probability, it further determines whether the authentication probability is greater than the authentication probability threshold; if yes, the number corresponding to the authentication probability threshold is determined, and the number corresponding to the authentication probability threshold is determined as the first number of channel blocks for signal authentication.

It should be noted that the first number is the minimum number of channel blocks that may satisfy the authentication probability threshold. When the minimum number of channel blocks is selected according to the requirements of the authentication probability, the complexity of the aware receiver 4 may be reduced.

In step 203, The aware receiver 4 authenticates the signal in the first number of channel blocks.

Specifically, the aware receiver 4 may authenticate the signals in the first number of channel blocks by:
determining a second quantity of tag signals in the first number of channel blocks;
determining whether the second quantity is greater than a preset value threshold;
if the second quantity is greater than the value threshold, determining that the signal in the first number of channel blocks is a label signal, wherein the label signal is an authentication signal received by the aware receiver 4;
if the second quantity is less than the value threshold, determining that the signal in the first number of channel blocks is a regular signal, wherein the regular signal is a non-authentication signal received by the aware receiver 4.

In this embodiment, it has been presupposed that the channel fading experienced by each channel block is independent of the others, and the authentication decision results corresponding to different channel blocks are also independent of each other. It is assumed that the second quantity of the label signal in the first number of channel blocks is represented as

x=Σᵢδᵢ

Here, for total number K of blocks, δᵢ means the detection-decision result for the i'th block where δᵢ=1 if the i'th block is authenticated otherwise δᵢ=0. Thus, x=Σᵢ δᵢ means the number of authenticated blocks and x follows a binomial distribution. The first quantity may be represented by K. If there is no label signal in the signal, detection probability of authenticated blocks more than k blocks is:

$$\begin{matrix}f ( x > {k}_{0} \vert {H}_{0} ) = 1 - {B}_{CDF} ( k , K , {ϵ}_{FA} ) ) & ( 1.12 ) \\ {k}^{0} = arg {min}_{k} [ 1 - {B}_{CDF} k , K , {ɛ}_{FA} < {ɛ}_{FA}^{K} ] & ( 1.13 )\end{matrix}$$

where B_{PMF}(x, K, p) is a binomial probability mass function (PMF) of obtaining exactly x successes in K identical and independent trials with the probability of success p, and B_{CDF}(x, K, p) is the corresponding binomial cumulative distribution function (CDF). We compare x with a threshold k⁰ to ensure that the probability of false alarm (PFA) in K blocks does not exceed the new threshold e_{FA}^{K}.

The decision of authenticity δ_{K} for K blocks is denoted as

$${δ}_{K} = \{ \begin{matrix}1 , & x > {k}^{0} \\ π , & x = {k}^{0} \\ 0 , & x < {k}^{0}\end{matrix} \qquad ( 1.13 )$$

where π=[(ε_{FA}^{K}+B_{CDF}(k⁰,K,ε_{FA})−1]/B_{PMF}(k⁰,K,ε_{FA}) is the randomization of the detection rule.

If the second quantity, represented as x, is greater than the value threshold k₀, the signal in the K channel blocks could be determined as a label signal, and if the second quantity, represented as x, is less than the value threshold k₀ the signal in the K channel blocks may be classified as, that is, determined to be, a conventional signal. If the second number, expressed as x, is equal to the value threshold k₀, no decision is made on the signals in the K channel blocks.

In addition, for a randomly selected group of K tagged signal blocks, the detection probability of correctly deciding H₁ is simply

f(x>k⁰|H₁)=1−B_{CDF}(k⁰,K,P_{D})+(1−p)B_{PMF}(k⁰,K,P_{D}) (1.14)

where P_{D} is the probability of detection for a randomly observed block, as defined in (1.11).

In the method flow described in FIG. 2, after receiving the signal sent by the transmitting device 3, the aware receiver 4 may determine the first number of channel blocks for performing signal authentication according to the authentication probability, and further, in the first number of channel blocks. The signal is authenticated, that is, the signals in the plurality of channel blocks are authenticated, which is more robust than the authentication of the signals in a single channel block, such that the robustness of the information authentication may be ensured.

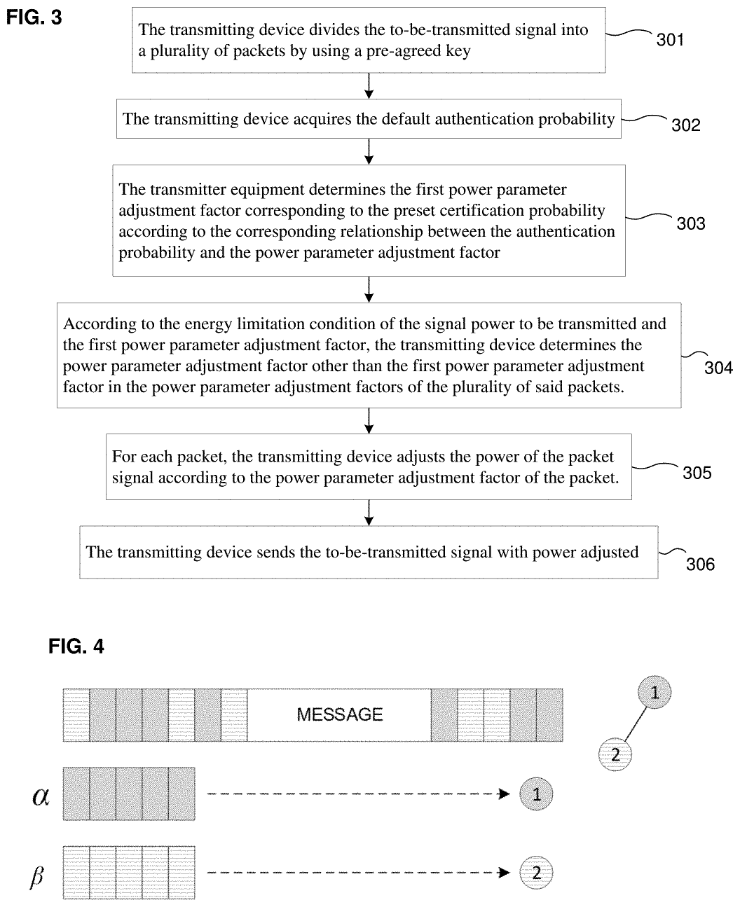

Another wireless communication method may be applicable to the transmitting device 3 as well. As shown in FIG. 3, the wireless communication method may include the following steps:

In step 301, the transmitting device 3 divides the to-be-transmitted signal into a plurality of packets by using a pre-agreed key.

In one embodiment, before transmitting the to-be-transmitted signal, the transmitting device 3 may divide the signal to be transmitted into multiple packets by the pre-agreed key, wherein the number of specific packets and the length of each packet of signals may be determined by the key that is pre-agreed upon and known by the aware receiver 4 and transmitting device 3.

For example, an N-length string of information signal and an N-length string of keys may be provided, where N is a positive integer. The number of 0's and 1's in the key may be the same. The information signal may be aligned with the key by the transmitting device 3, the bits in the information signal corresponding to 0's of the key may be divided into a first packet, and the bits in the information signal corresponding to 1's of the key may be divided into a second packet. That is, the information signal could be divided into two packets. For the sake of simplicity, the following description refers to only two packets.

For simplicity, the following sections are described in two parts.

In step 302, the transmitting device 3 acquires a default authentication probability. In the embodiment of the invention, the robustness of the system is related to the probability of authentication. When the robustness of the system is considered, an ideal authentication probability may be set up in advance. Under the preset authentication probability, the robustness of the system is better.

In step 303, the transmitting device 3 determines the first power parameter adjustment factor corresponding to the preset authentication probability according to the corresponding relationship between the authentication probability and the power parameter adjustment factor.

Among them, the authentication probability is negatively correlated with the power parameter adjustment factor in the corresponding relationship between the authentication probability and the power parameter adjustment factor.

In an embodiment of the invention, the corresponding relationship between the probability of authentication and the power parameter adjustment factor may be obtained through multiple tests in advance. After obtaining the preset authentication probability, the first power parameter adjustment factor corresponding to the preset authentication probability may be determined according to the corresponding relationship between the authentication probability and the power parameter adjustment factor.

To be sure, the authentication probability and the power parameter adjustment factor may be established by the transmitting device 3 and aware receiver 4 through mutual communication. Each time, before the transmitting device 3 sends a signal, the transmitting device 3 may receive feedback information sent by the aware receiver 4, which is used to represent the corresponding relationship between the authentication probability and the power parameter adjustment factor.

In step 304, according to the energy limitation condition of the signal power to be transmitted and the first power parameter adjustment factor, the transmitting device 3 may determine the other power parameter adjustment factors of the plurality of said packets.

In an embodiment, the transmitting device 3 needs to determine a power parameter adjustment factor for each packet. After determining the first power parameter adjustment factor corresponding to the preset authentication probability for the transmitting device 3, the other power parameter adjustment factor of the multiple packets, in addition to the first power parameter adjustment factor, may be determined according to the energy limitation condition of the signal power to be transmitted and the first power parameter adjustment factor. Among them, according to the principle that the total energy of the signal does not change before and after the adjustment, when power parameter adjustment is carried out, the power parameter adjustment factor of the signal to be sent needs to meet the energy constraint condition. For example, the energy constraint condition of the power of the signal to be sent could be expressed as:

a²/2+b²/2=1

For example, transmitting device 3 may determine the first power parameter adjustment factor corresponding to the preset authentication probability according to the corresponding relationship between the authentication probability and the power parameter adjustment factor β=0.8. Further, knowing β=0.8 and a²/2+b²/2=1, the other power parameter adjustment factor of the multiple packets, other than the first power parameter adjustment factor, may be determined, that is, the second power parameter adjustment factor α may be determined.

In step 305, for each group, the transmitting device 3 may adjust the signal power of each group according to corresponding power parameter adjustment factor.

Please refer also to FIG. 4. FIG. 4 is a schematic diagram of a power distribution mechanism of a signal according to an embodiment. As shown in FIG. 4, the signal may be divided into two packets, that is, the first group and the second group. The transmitting device 3 may multiply the signal power of the first group by the power parameter adjustment factor α and multiply the signal power of the second group by the power parameter adjustment factor β to adjust the signal power for each group. Among them, the condition 0≤β<1<α should be met. The two tag signals may be expressed as follows:

x_{i,1}(l₁)=αsᵢ(l₁)

x_{i,2}(l₂)=βsᵢ(l₂) (1.11)

where l₁≠l₂ ∈{1, . . . , L/2} represents the subscript of each group. The length of signals in packets x_{i,1} and x_{i,2} are both L/2 and α and β also need to satisfy the energy-limited condition of the signal power, that is, α²/2+β²/2=1, so the ranges of α and β may be further changed to 0≤b<1<a≤√2. In Step 306, the transmitting device 3 sends the to-be-transmitted signal with power adjusted.

In an embodiment, after the transmitting device 3 performs power adjustment on each group, a certain power allocation feature may be formed, and the to-be-transmitted signal with power adjusted is sent to the aware receiver 4. The features of power allocation may include: a tag signal, a power parameter adjustment factor, and a group mode (i.e., which locations belong to the first group).

In the method flow described in FIG. 3, before transmitting the to-be-transmitted signal, the transmitting device 3 may use the key agreed by the two parties to divide the transmitted signals into multiple packets, and according to the authentication probability and energy constraint conditions, the power parameter adjustment factors of multiple packets are determined, and then the power parameter adjustment factors are used to adjust the signal power of each packet before sending them out.

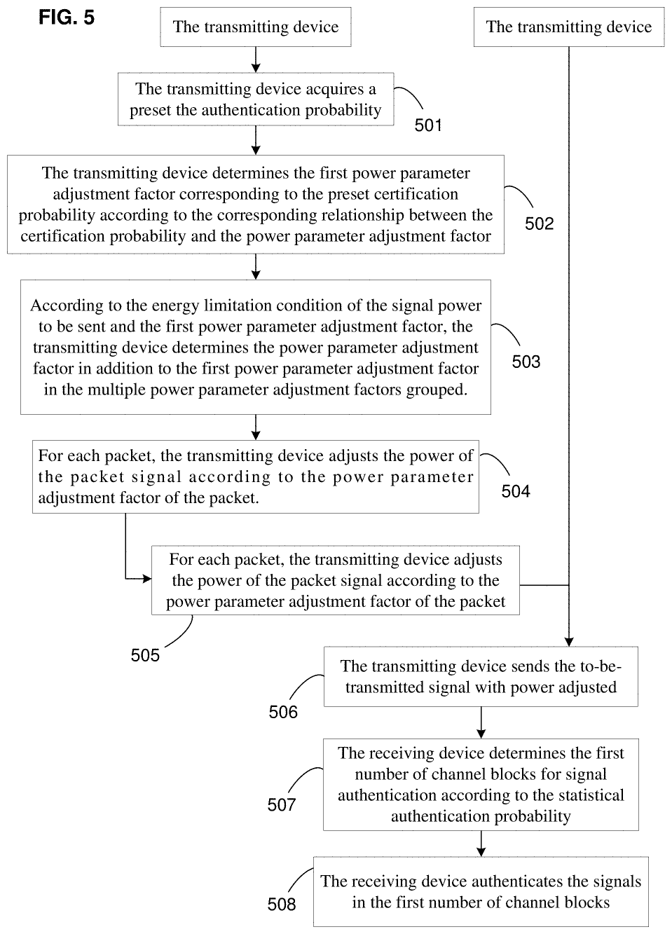

Referring to FIG. 5, FIG. 5 is a schematic flowchart diagram of another wireless communication method according to an embodiment. The wireless communication method is described for a combined system of both the transmitting device 3 and the aware receiver 4. As shown in FIG. 5, the wireless communication method may include the following steps:

In step 501, the transmitting device 3 divides the to-be-transmitted signal into a plurality of packets by using a pre-agreed key.

In step 502, the transmitting device 3 acquires a preset the authentication probability.

In step 503, the transmitting device 3 determines the first power parameter adjustment factor corresponding to the preset authentication probability according to the corresponding relationship between the authentication probability and the power parameter adjustment factor.

In step 504, according to the energy limitation condition of the signal power to be sent and the first power parameter adjustment factor, the transmitting device 3 determines the other power parameter adjustment factors, in addition to the first power parameter adjustment factor, in the multiple power parameter adjustment factors packeted.

In step 505, for each group, the transmitting device 3 adjusts the power of the group signal according to the power parameter adjustment factor of the group.

In Step 506, the transmitting device 3 sends the to-be-transmitted signal with power adjusted.

In Step 507, the aware receiver 4 determines the first number of channel blocks for signal authentication according to the statistical authentication probability.

In Step 508, the aware receiver 4 authenticates the signals in the first number of channel blocks.

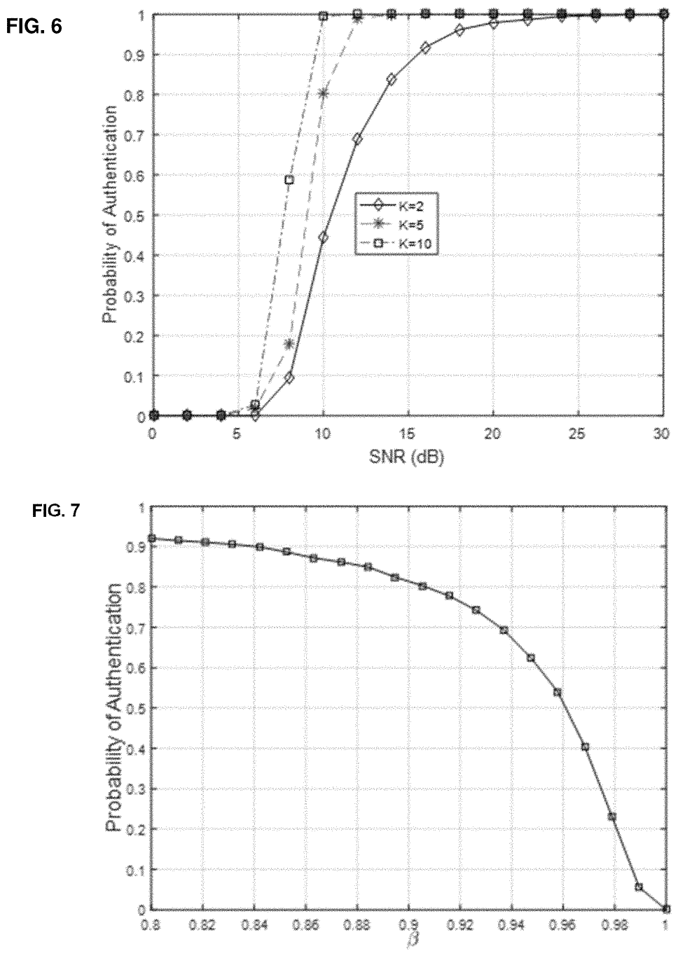

Please refer to FIG. 6 and FIG. 7 together. FIG. 6 is a schematic diagram of the relationship between the authentication probability and SNR under a variety of number of channel blocks disclosed by the embodiment of the invention; FIG. 7 is a schematic diagram of the relationship between the authentication probability and the power parameter adjustment factor disclosed in the illustrated embodiment of the invention. FIG. 6 shows the curved relationship between the authentication probability and SNR three different numbers (2, 5, and 10, respectively) of channel blocks.

From FIG. 6, one can observe that the robustness of the proposed Auth-SLO method improves gradually as the number of blocks increases. For example, for making the value of the authentication probability to achieve 1, the case with K=2 requires the SNR to be more than 25 dB, whereas the case with K=10 requires only that the SNR be more than 10 dB.

Therefore, in order to ensure the robustness of authentication technology, as many channel blocks as possible may be used for authentication. FIG. 7 shows the curve relationship between the authentication probability and the power parameter adjustment factor β. As may be seen from FIG. 7, the authentication probability decreases from 1 to 0 gradually with the increase of the adjustment factor β. Therefore, in order to ensure the robustness of the system authentication, the power parameter adjustment factor should be designed with a smaller value β.

Compared with the existing wireless communication physical layer authentication technologies (Auth-SS, Auth-SUP, Auth-TDM), using the Auth-SLO authentication technology described above, the wireless communication physical layer may be authenticated without occupying additional signal bandwidth. At the same time, the tag signal does not affect noise extraction and noise statistical characteristics in the aware receiver 4. In addition, the security of the Auth-SLO authentication technology described herein has better robustness than that of the prior art, both in terms of spectrum characteristics analysis and impact on other users in the communication scenario.

In the method described in FIG. 5, before transmitting the to-be-transmitted signal, the transmitting device 3 may use the key agreed on by the two parties to divide the transmitted signals into multiple packets, and determine the power parameter adjustment factors of multiple packets according to the authentication probability and energy limit conditions. Then, the signal power of each packet may be distributed and adjusted by using the determined power parameter adjustment factor. At the same time, the aware receiver 4 may also determine the first number of channel blocks for signal authentication according to the authentication probability. Then the signals in the first number of channel blocks may be authenticated, that is, the signals in multiple channel blocks may be authenticated. An authentication decision made based on multiple blocks is more robust than that based on single block.

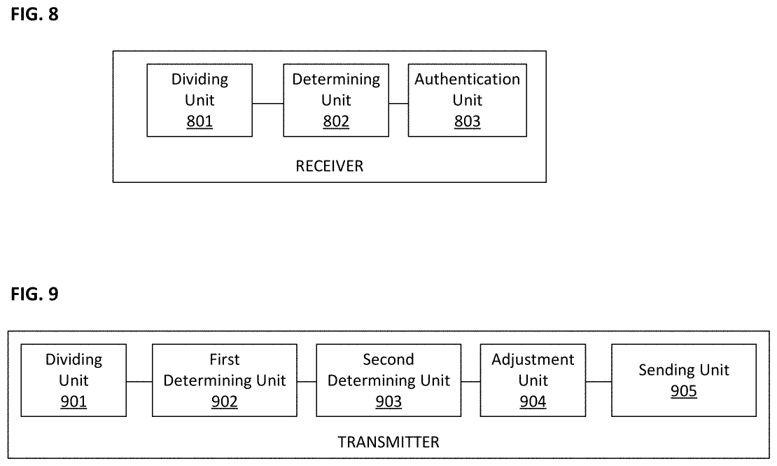

Please refer to FIG. 8. FIG. 8 is a schematic structural diagram of a wireless communication apparatus according to one embodiment, in which the wireless communication apparatus runs on the aware receiver 4. The wireless communication apparatus described in FIG. 8 may perform some or all of the steps in the wireless communication method described in FIG. 2 and FIG. 5. As shown in FIG. 8, the wireless communication apparatus may include:

A receiving unit 801, for receiving signals sent by transmitting device 3; a determining unit 802, for determining the first number of channel blocks for signal authentication according to the statistical authentication probability; and an authentication unit 803, for authenticating the signals in the first number of channel blocks.

The authentication unit 803 may authenticate the signals in the first number of channel blocks as follows:
determine the second number of label signals in the first number of channel blocks;
determine whether the second quantity is greater than the preset value threshold;
if the second number is greater than the value threshold, the signal in the first number of channel blocks may be determined to be a label signal, wherein, the label signal is the authentication signal received by the receiver device;
if the second number is less than the value threshold, the signal in the first number of channel blocks may be classified as a conventional signal, where the conventional signal is an unauthenticated signal received by the receiver device.

According to the statistical authentication probability of 802, a way to determine the first number of channel blocks for signal authentication is as follows:
according to the received signals, the authentication probability is statistically verified;
a determination is made as to whether the authentication probability is greater than the authentication probability threshold;
if so, the number corresponding to the authentication probability threshold is obtained, and the number corresponding to the authentication probability threshold is determined as the first number of channel blocks for signal authentication.

As illustrated in FIG. 8, the wireless communication device, after receiving signal sent by a transmitting device 3, may determine the number of the first channel block for authentication based on the probability of authentication, then the number of signals in the first channel block may be authenticated, that is, the signals in multiple channel blocks could be authenticated; an authentication decision made based on multiple blocks is more robust than that based on single block.

Please refer to FIG. 9, which is a schematic structural diagram of another wireless communication apparatus according to an embodiment. The wireless communication apparatus shown in FIG. 9 may be applied in a transmitting device 3. The wireless communication apparatus described in FIG. 9 may perform some or all of the steps in the wireless communication method described in FIG. 3 and FIG. 5. As shown in FIG. 9, the wireless communication apparatus may include:
a dividing unit 901, to divide the to-be-transmitted signal into multiple packets by using a pre-agreed key; and a first determination unit 902, used to determine the first power parameter adjustment factor corresponding to the preset authentication probability according to the corresponding relationship between the authentication probability and the power parameter adjustment factor;
a second determination unit 903, to determine the other power parameter adjustment factor, in addition to the first power parameter adjustment factor, of multiple packets according to the energy limitation condition of the signal power to be transmitted and the first power parameter adjustment factor;
an adjustment unit 904, to adjust the signal power of each packet according to the power parameter adjustment factor of the packet; and
a sending unit 905, to send the signal to be sent after adjusting the power.

Among them, the authentication probability is negatively correlated with the power parameter adjustment factor in the corresponding relationship between the authentication probability and the power parameter adjustment factor.

Before sending the signal to be sent, the wireless communication device illustrated in FIG. 9 may group the signals to be sent by using the key agreed by both parties, determine the power parameter adjustment factors of multiple packets according to the authentication probability and energy limit conditions, adjust the signal power of each packet by using the determined power parameter adjustment factors, and then send the signals out.

The above-described integrated unit implemented in the form of a software function module may be stored in a computer-readable storage medium, which may store a computer program, which, when executed by a processor, may implement the steps in the foregoing various method embodiments. The computer program comprises computer program code, which may be in the form of source code, object code form, executable file or some intermediate form. The computer readable storage medium may include any entity or device capable of carrying the computer program code, a recording medium, a USB flash drive, a removable hard disk, a magnetic disk, an optical disk, a computer memory, a read only memory (ROM, Read-Only Memory), random access memory (RAM, Random-Access Memory), electrical carrier signals, telecommunications signals, and software distribution media. It should be noted that the content contained in the computer-readable storage medium may be appropriately increased or decreased according to the requirements of legislation and patent practice in a jurisdiction.

In the above embodiments, the descriptions of the various embodiments are all focused on, and the parts that are not detailed in a certain embodiment may be referred to the related descriptions of other embodiments.

In the several embodiments provided herein, it should be understood that the disclosed apparatus may be implemented in other ways. For example, the device embodiments described above are merely illustrative. For example, the division of the units is only a logical, functional division, and the actual implementation may have another division manner. For example, multiple units or components may be combined or integrated into another system, or some features may be omitted or not implemented. In addition, the coupling or direct coupling or communication connection shown or discussed may be an indirect coupling or communication connection through some interface, device or unit, and may be electrical or otherwise.

The units described as separate components may or may not be physically separated, and the components displayed as units may or may not be physical units, that is, may be located in one place, or may be distributed to multiple network units. Some or all of the units may be selected according to actual needs to achieve the purpose of the solution of an embodiment.

In addition, each functional unit in each embodiment may be integrated into one processing unit, or each unit may exist physically separately, or two or more units may be integrated into one unit. The above integrated unit may be implemented in the form of hardware or in the form of a software functional unit.

The integrated unit, if implemented in the form of a software functional unit and sold or used as a standalone product, may be stored in a computer readable memory. Based on such understanding, the technical solution of the disclosure may contribute to the prior art or all or part of the technical solution may be embodied in the form of a software product. The computer software product is stored in a memory and includes instructions for causing a computer device (which may be a personal computer, server or network device, etc.) to perform all or part of the steps of the methods described in various embodiments of the disclosure. The foregoing memory includes: a U disk, a Read-Only Memory (ROM), a Random Access Memory (RAM), a removable hard disk, a magnetic disk, or an optical disk, and the like, which may store program codes.

One of ordinary skill in the art will appreciate that all or part of the various steps of the above-described embodiments may be accomplished by a program instructing the associated hardware. The program may be stored in a computer readable memory, and the memory may include: a flash disk, a read-only memory (ROM), a random access memory (RAM), disk or CD, etc.

The wireless communication method and apparatus described for the various embodiments are described in detail above. The principles and embodiments of the disclosure have been described herein with reference to specific examples, and the description of the above embodiments is only to assist in understanding the method of the disclosure and its core idea. At the same time, for the general technician in this field, there will be some changes in the specific implementation and application scope according to the idea of this disclosure. In summary, the contents of this specification should not be understood as a limitation to the disclosure.

What is claimed is:

1. A wireless communication method, used in a receiving device, comprising:
receiving signals sent by a transmitting device, said signals comprising a plurality of channel blocks;
determining a first number of channel blocks for signal authentication according to an authentication probability, said first number of channel blocks being fewer in number than the plurality of channel blocks; and
authenticating signals in the first number of channel blocks.

2. The method of claim 1, said step of authenticating signals in the first number of channel blocks including:
determining a second number of label signals in the first number of channel blocks;
determining whether the second number is greater than a preset value threshold;
if the second number is greater than the value threshold, classifying the signal in the first number of channel blocks as a label signal, wherein the label signal is an authentication signal received by the receiving device;
if the second number is less than the value threshold, classifying the signal in the first number of channel blocks as non-authentication signal received by the receiving device.

3. The method according to claim 2, wherein said step of determining the first number of channel blocks includes:
computing the authentication probability of the received signals; and
determining whether the authentication probability is greater than an authentication probability threshold and, if so obtaining a value corresponding to the authentication probability threshold, and setting the value corresponding to the authentication probability threshold as the first number of channel blocks for signal authentication.

4. The method according to claim 1, wherein said step of determining the first number of channel blocks includes:
computing the authentication probability of the received signals; and
determining whether the authentication probability is greater than an authentication probability threshold and, if so obtaining a value corresponding to the authentication probability threshold, and setting the value corresponding to the authentication probability threshold as the first number of channel blocks for signal authentication.

5. A wireless communication method, applied to a transmitting device, comprising:
grouping a to-be-transmitted signal into multiple packets by using a pre-agreed key;
determining a preset authentication probability;
determining a first power parameter adjustment factor corresponding to the preset authentication probability;
receiving back from the receiver channel state information (CSI);
estimating authentication performance from the CSI;
determining a second power parameter adjustment factor as a function of the first power parameter adjustment factor and an energy-limited condition of the to-be-transmitted signal power;
if the estimated authentication performance fails to meet a robustness requirement, adjusting the first and second power parament adjustment factors;
for each of the packets, performing power adjustment to the signal according to power parameter adjustment factors; and
transmitting the to-be-transmitted signal after said power adjustment;

6. The method according to claim 5, wherein the authentication probability is negatively correlated with the power parameter adjustment factor.

7. A wireless communication device, applied in a receiving device, comprising:
a receiving unit, for receiving a signal sent by the transmitting device;
a determining unit, for determining a first number of channel blocks for performing signal authentication according to an authentication probability, said first number of channel blocks being fewer in number than the plurality of channel blocks; and
an authentication unit, for authenticating signals in the first number of channel blocks.

8. The wireless communication device according to claim 7, wherein the authentication unit authenticates signals in the first number of channel blocks by the following steps:
determining a second number of tag signals in the first number of channel blocks;
determining whether the second number is greater than a preset value threshold;
if the second number is greater than a value threshold, determining that the signal in the first number of channel blocks is a tag signal wherein the tag signal is an authentication signal received by the receiving device;
if the second quantity is less than the value threshold, determining that the signal in the first number of channel blocks is a regular signal, wherein the regular signal is a non-authentication signal received by the receiving device.

9. The wireless communication device according to claim 7, wherein the determining unit determines the first number of channel blocks for performing signal authentication according to the authentication probability by the following steps:
computing the authentication probability according to the received signal;
determining whether the authentication probability is greater than an authentication probability threshold;
if the authentication probability is greater than the authentication probability threshold, determining a value corresponding to the authentication probability threshold, and determining the value corresponding to the authentication probability threshold as the first number of channel blocks for signal authentication.

10. The wireless communication device according to claim 8, wherein the determining unit determines the first number of channel blocks for performing signal authentication according to the authentication probability by the following steps:
computing the authentication probability according to the received signal;
determining whether the authentication probability is greater than an authentication probability threshold;
if the authentication probability is greater than the authentication probability threshold, determining a value corresponding to the authentication probability threshold, and determining the value corresponding to the authentication probability threshold as the first number of channel blocks for signal authentication.
